(19) United States
(12) Patent Application Publication
(10) Pub. No.: US 2019/0100829 A1
(43) Pub. Date: Apr. 4, 2019

(54) RECONDITIONING A CORE FOR USE IN AN ENERGY RECOVERY DEVICE

(71) Applicant: Exergyn Limited, Dublin (IE)

(72) Inventor: Georgiana Tirca-Dragomirescu, Dublin (IE)

(21) Appl. No.: 15/536,920

(22) PCT Filed: Dec. 17, 2015
(86) PCT No.: PCT/EP2015/080338

§ 371 Date: Jun. 16, 2017

(51) Int. Cl. C22F 1/00; C22F 1/10; F03G 7/06; F02B 73/00

(52) U.S. Cl. CPC C22F 1/006; F02B 73/00; F03G 7/065; C22F 1/10

(57) ABSTRACT

A system and method of reconditioning a SMA or NTE material based core for use in an energy recovery device comprising the step of heating the core for a period of time above a certain temperature to configure the core with its original properties. The system and method can be implemented on site of an energy recovery device or remotely.

### FIELD

The present application relates to the field of energy recovery and in particular to the use of shape memory alloys (SMA) or Negative Thermal Expansion materials (NTE) for same.

### BACKGROUND

Low grade heat, which is typically considered less than 100 degrees, represents a significant waste energy stream in industrial processes, power generation and transport applications. Recovery and re-use of such waste streams is desirable. An example of a technology which has been proposed for this purpose is a Thermoelectric Generator (TEG). Unfortunately, TEGs are relatively expensive. Another largely experimental approach that has been proposed to recover such energy is the use of Shape-Memory Alloys.

A Shape-Memory Alloy (SMA) is an alloy that “remembers” its original, cold-forged shape which once deformed returns to its pre-deformed shape upon heating. This material is a lightweight, solid-state alternative to conventional actuators such as hydraulic, pneumatic, and motor-based systems.

A heat engine concept is under development which utilises Shape-Memory Alloy (SMA) or another Negative Thermal Expansion (NTE) material as the working medium that acts within a core. In such an engine, for example as disclosed in PCT Patent Publication number WO2013/087490 and assigned to the assignee of the present invention, the forceful contraction of such material on exposure to a heat source is captured and converted to usable mechanical work.

Thus far, a useful material for such a working mass has been found to be Nickel-Titanium alloy (NiTi). This alloy is a well-known Shape-Memory Alloy and has numerous uses across different industries.

For example, NiTi wires form the working element of the engine described in WO2013/087490. Force is generated through the contraction and expansion of the wire elements within the working core, via a piston and crank mechanism. An important aspect of this system is the ability to secure the NiTi elements at both ends such that a strong and reliable union is created, enabling high-force, low displacement work to be performed for a maximum number of working cycles.

Due to the repeated contraction and expansion of the SMA or NTE over a large number of cycles a problem exists that the SMA or NTE core material degrades over time with use resulting in inefficient operation. One solution is to replace the core entirely, however, this is complex and a costly operation.

It is therefore an object of the invention to provide a system and method to overcome the above mentioned problem.

### SUMMARY

According to the invention there is provided, as set out in the appended claims, a method of reconditioning a SMA or NTE material based core for use in an energy recovery device comprising the step of heating the core for a period of time above a certain temperature to configure the core with its original properties.

The method and system of the invention enhances the working life of the NiTi wires and avoids their loss in performance caused by thermo-mechanical cycling. It will be appreciated that the system and method can be implemented on the site of an energy recovery device or remotely.

In one embodiment there is provided the step of selecting a temperature above the Austenite finish temperature of the core for a certain period of time.

In one embodiment the core is fatigued or compromised before said heating step.

In one embodiment the step of heating can be provided from at least one of: a heating element; an induction furnace; a liquid; an oil; or a sand bath.

In one embodiment there is provided the step of heating repeated periodically.

In one embodiment a signal can be supplied remotely to control the step of heating the core. It will be appreciated that any communication means can be used to supply the signal remotely to control the heating of the core.

In one embodiment the heating step involves selecting a temperature Tₕ above the austenite finish temperature, A_{f}, of the core such that the heating reverts stress-induced martensite (SIM) back into austenite to partly revoke the degradation of shape memory properties.

In one embodiment there is provided means for selecting a temperature above the Austenite finish temperature of the core for a certain period of time.

In one embodiment the core is fatigued or compromised before said heating.

In one embodiment the heating module comprises at least one of: a heating element; an induction furnace; a liquid; an oil; or a sand bath.

In one embodiment the heating is repeated periodically.

In one embodiment a signal can be supplied remotely to control the heating module for heating the core.

In one embodiment the heating module is configured to select a heating temperature Tₕ above the austenite finish temperature, A_{f}, of the core such that the heating reverts stress-induced martensite (SIM) back into austenite to partly revoke the degradation of shape memory properties.

In another embodiment of the invention there is provided a system to recondition a SMA or NTE material based core for use in an energy recovery device comprising a module adapted for heating the core for a period of time above a certain temperature to configure the core with its original properties.

In one embodiment there is provided means for selecting a temperature above the Austenite finish temperature of the core for a certain period of time.

In one embodiment the heating module comprises at least one of: a heating element; an induction furnace; a liquid; an oil; or a sand bath.

In one embodiment a signal can be supplied remotely to control the heating module for heating the core.

### BRIEF DESCRIPTION OF THE DRAWINGS

The invention will be more clearly understood from the following description of an embodiment thereof, given by way of example only, with reference to the accompanying drawings, in which:

FIG. 1 illustrates a prior art energy recovery system using SMA or NTE materials;

FIG. 2 illustrates an embodiment of a core in operation with a plurality of SMA or NTE elements;

FIG. 3 illustrates a healing sequence of healing of the SMA in the core of an energy recovery device, which can be repeated multiple times; and

FIG. 4 illustrates a comparison of temperature vs. displacement curves for healed and fatigued SMA wires to confirm operation of the invention.

### DETAILED DESCRIPTION OF THE DRAWINGS

The invention relates to a heat recovery system under development which can use either Shape-Memory Alloys (SMA) or Negative Thermal Expansion materials (NTE) to generate power from low grade heat.

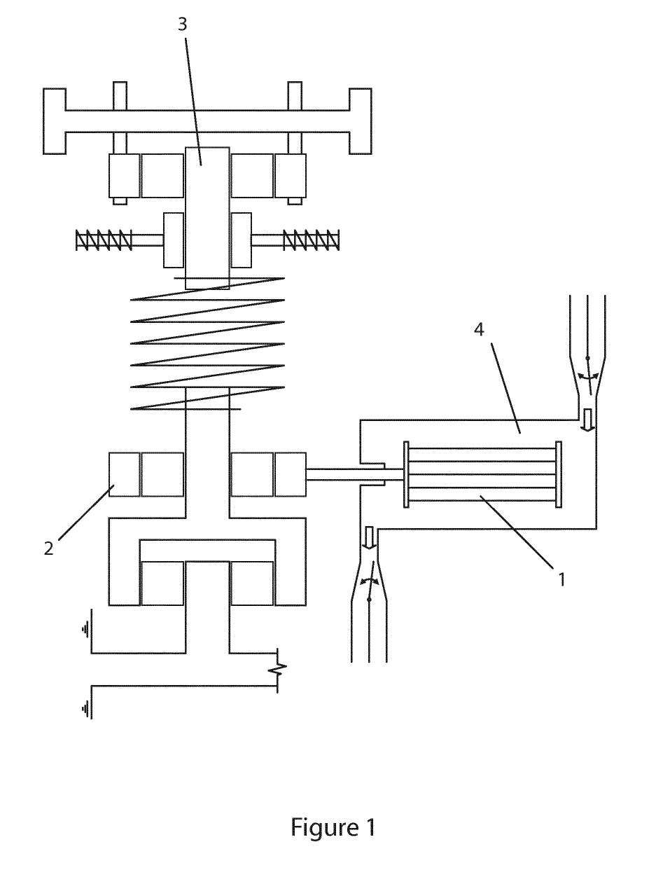

An exemplary known embodiment of an energy recovery device will now be described with reference to FIG. 1 which provides an energy recovery device employing a SMA engine indicated by reference numeral 1. The SMA engine 1 comprises an SMA actuation core. The SMA actuation core is comprised of SMA material clamped or otherwise secured at a first point which is fixed. At the opposing end, the SMA material is clamped or otherwise secured to a drive mechanism 2. Thus whilst the first point is anchored the second point is free to move albeit pulling the drive mechanism 3. An immersion chamber 4 is adapted for housing the SMA engine and is adapted to be sequentially filled with fluid to allow heating and/or cooling of the SMA engine. Accordingly, as heat is applied to the SMA core it is free to contract. Suitably, the SMA core comprises a plurality of parallel wires, ribbons or sheets of SMA material. Typically, a deflection in and around 4% is common for such a core. Higher deflections can also be acheived. Accordingly, when a 1 m length of SMA material is employed, one might expect a linear movement of approximately 4 cm to be available. It will be appreciated that the force that is provided depends on the mass of wire used. Such an energy recovery device is described in PCT Patent Publication number WO2013/087490, assigned to the assignee of the present invention, and is incorporated fully herein by reference.

For such an application, the contraction of SMA or NTE material on exposure to a heat source is captured and converted to usable mechanical work. A useful material for the working element of such an engine has been proven to be Nickel-Titanium alloy (NiTi). The SMA actuation core is comprised of a plurality of SMA materials clamped or otherwise secured at a first point which is fixed.

In order to secure the NiTi wires in the engine, it is required to develop a system that can anchor each wire at both ends, in such a fashion as will allow it to operate under high load. This system has been designated as the “bundle holder”.

Such a core is described in UK patent application number 1409679.6, assigned to Exergyn Limited, and is incorporated fully herein by reference. In this application a core engine is described for use in an energy recovery device comprising a plurality of Shape Memory Alloys (SMA) or Negative Thermal Expansion (NTE) elements fixed at a first end and connected at a second end to a drive mechanism. The holder is a holder configured with a plurality of slots adapted to receive the plurality of Shape Memory Alloys (SMA) or NTE elements, for example Nickel Titanium wires. The SMA wires are substantially elongated and arranged in a parallel orientation to make up a core that is housed in a chamber.

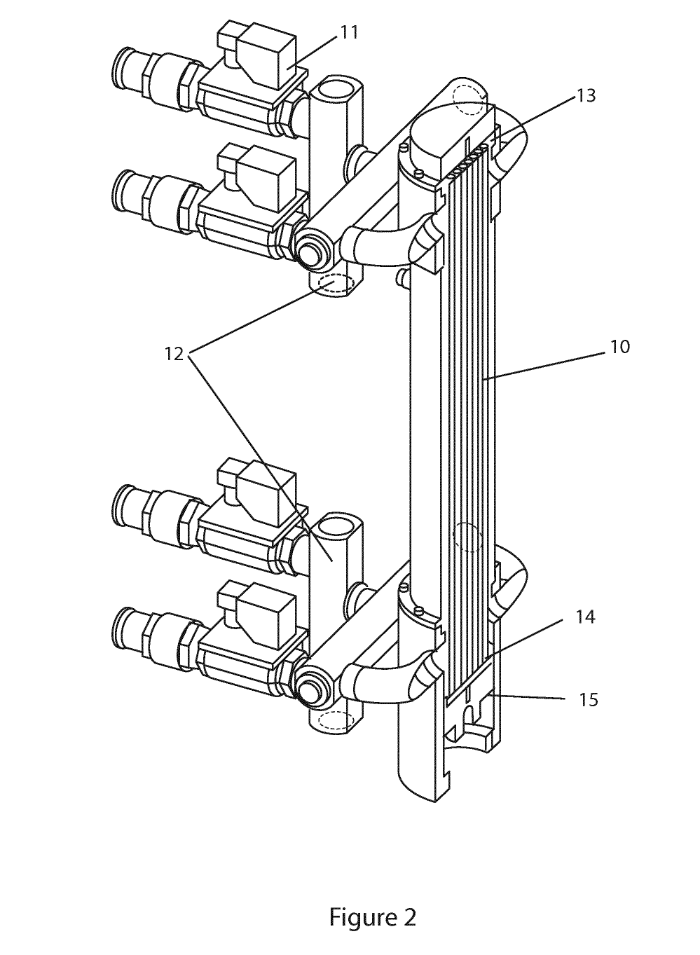

FIG. 2 illustrates an embodiment of a core in operation with a plurality of SMA or NTE wires 10 arranged in parallel in use in an energy recovery device. The core is housed in a chamber and is connected to a fluid source via valves 11 and manifolds 12. The SMA wires are secured at both ends by a bottom and top bundle holder 13 and 14. One end of the core is in communication with a piston 15 that is moveable in response to expansion and contraction of the SMA wires 10 to generate energy. The core enables a novel heat recovery system under development which can use either Shape Memory Alloys (SMA) or Negative Thermal Expansion materials (NTE) to generate power from low grade heat.

For such an application, the contraction of such material on exposure to a heat source is captured and converted to usable mechanical work. A useful material for the working element of such an engine has been proven to be Nickel-Titanium alloy (NiTi). This alloy is a well-known Shape-Memory Alloy and has numerous uses across different industries. Force is generated through the contraction and expansion of the alloy (embodied as a plurality of wires) within the working core, via a piston and transmission mechanism. As mentioned above due to the repeated contraction and expansion of the SMA or NTE over a large number of cycles a problem exists that the SMA or NTE core material degrades or fatigues over time with use resulting in inefficient operation.

Fatigue in Shape-Memory Alloys (SMAs) occurs due to the accumulation of defects and structural changes, which in turn leads not only to structural fatigue (i.e. crack initiation, crack growth and final rupture) but also to functional fatigue: when an SMA that exhibits pseudo-elastic behaviour is subjected to cyclic loading, accumulation of permanent strain ensues and the critical stresses for the forward and reverse transformation decrease. Functional fatigue has been attributed to either the accumulation of dislocations or the stabilization of martensite variants or a combination of these processes.

According to a first aspect of the invention it has been discovered that application of a controlled current, or other heating means or heat source, to heat the core results in the core returning to its original properties. In one embodiment of the invention there is provided a heat treatment that involves heating a cycled sample to a temperature Th above the austenite finish temperature, A_{f}, which reverts stress-induced martensite (SIM) back into austenite, can partly revoke the degradation of shape memory properties and hence enhance the functional fatigue performance of SMAs. This procedure is referred to as ‘healing’ or ‘reconditioning’ hereafter. In the context of the present invention the terms ‘healing’ or ‘reconditioning’ should be interpreted broadly to mean return the SMA or NTE material core to its desired properties as a result of degradation during use. It is well established that the stress-induced transformation in front of a crack tip can retard crack growth. Stabilization of martensite will locally reduce a microstructure's potential for stress relaxation and may therefore also have a detrimental effect on fatigue lives during structural fatigue.

The healing treatment involves the exposure of the shape memory alloy to a heat source that has a temperature above the Austenite finish temperature of the alloy for a certain period of time. This heat source can be presented as an induction furnace, a liquid; an oil or a sand bath. The temperature at which this post cycling heat treatment is performed is set for a pre-set period of exposure time to the heat source.

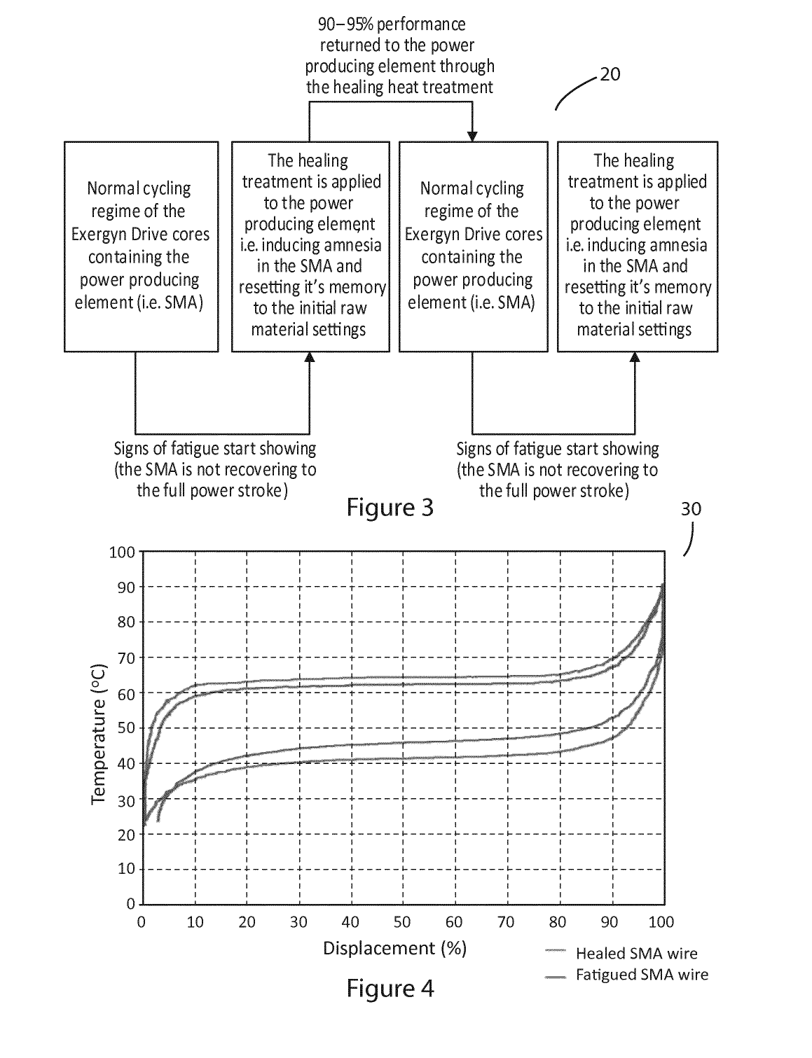

The system and method of the invention enhances the fatigue life of SMA components through periodic healing treatments, which are simple to perform and yet significantly beneficial. The system can be embodied as one or more modules for heating the core and controlling the heating operation. The control can be done on site at the core or from a remote location. FIG. 3 illustrates a flowchart of the healing or reconditioning process according to one embodiment of the invention, indicated generally by the reference numeral 20. The healing treatment is performed by heating the core to a desired temperature which can be done periodically or when degradation in the core operation is detected. Detection can be performed by a closed control loop with an appropriate sensor to monitor operation of the core. With regard to the heating of the core to recondition, the heating can be provided from a number of sources with an associated module configured to control the heating of the core. Detection and the heating module can be controlled remotely by supplying control signals from a central control station to a remote site where the core is located. The control signals can be supplied over any suitable communications link. One has to keep in mind that the healing treatments are effective only when they are performed in a ‘timely’ manner, i.e. before some sort of permanent damage is created within the material. A particular advantage of healing and in turn enhancing the fatigue life of the components is that dismantling the whole structure to replace old, fatigued wires with new ones can be too expensive or simply just not possible.

FIG. 4 shows that the healing has induced ‘amnesia’ in the SMA wire, i.e. making it ‘forget’ the hot and cold shapes imbedded by thermos-mechanical cycling, indicated by the reference numeral 30. The middle curves in the figure represent the memory of the alloy developed after 500+ cycles (the curve is narrow indicating that a memory effect is embedded in the wire). The upper and lower curve is wider and was obtained after the SMA wire was subjected to the healing heat treatment. The behaviour embedded in the memory of the wire was completely erased allowing for the recovery of the characteristics previous to the thermos-mechanical cycling regime.

Besides the obvious advantage of resetting the memory of the alloy, the healing heat treatment can improve the quality of the wire's surface, if any damage has been caused during the thermo-mechanical cycling in the energy recovery device.

It will be appreciated that in the context of the present invention that SMA materials are described, the invention can be applied to the general class of NTE materials that make up a core for use in an energy recovery device.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A method of reconditioning a SMA or NTE material based core for use in an energy recovery device comprising the step of heating the core for a period of time above a certain temperature to configure the core with its original properties.

2. The method of claim 1 comprising the step of selecting a temperature above the Austenite finish temperature of the core for a certain period of time.

3. The method of claim 1 wherein the core is fatigued or compromised before said heating step.

4. The method of claim 1 wherein the step of heating can be provided from at least one of: a heating element; an induction furnace; a liquid; an oil; or a sand bath.

5. The method of claim 1 wherein the step of heating is repeated periodically.

6. The method of claim 1 wherein a signal can be supplied remotely to control the step of heating the core.

7. The method of claim 1 wherein the heating step involves selecting a temperature Tₕ above the austenite finish temperature, A_{f}, of the core such that the heating reverts stress-induced martensite (SIM) back into austenite to partly revoke the degradation of shape memory properties.

8. A system to recondition a SMA or NTE material based core for use in an energy recovery device comprising a module adapted for heating the core for a period of time above a certain temperature to configure the core with its original properties.

9. The system of claim 8 comprising means for selecting a temperature above the Austenite finish temperature of the core for a certain period of time.

10. The system of claim 8 wherein the core is fatigued or compromised before said heating.

11. The system as claimed in claim 8 wherein the heating module comprises at least one of: a heating element; an induction furnace; a liquid; an oil; or a sand bath.

12. The system as claimed in claim 8 wherein the heating is repeated periodically.

13. The system as claimed in claim 8 wherein a signal can be supplied remotely to control the heating module for heating the core.

14. The system as claimed in claim 8 wherein the heating module is configured to select a heating temperature Tₕ above the austenite finish temperature, A_{f}, of the core such that the heating reverts stress-induced martensite (SIM) back into austenite to partly revoke the degradation of shape memory properties.

15. The system as claimed in claim 8 wherein the core comprises a plurality of elongated SMA or NTE elements.

16. The system as claimed in claim 8 comprising a detector configured to monitor operation of the core.

17. The method of claim 2 wherein the core is fatigued or compromised before said heating step.

18. The method of claim 2 wherein the step of heating can be provided from at least one of: a heating element; an induction furnace; a liquid; an oil; or a sand bath.

19. The method of claim 2 wherein the step of heating is repeated periodically.

20. The method of claim 2 wherein a signal can be supplied remotely to control the step of heating the core.
